(19) United States
(12) Patent Application Publication
(10) Pub. No.: US 2006/0290571 A1
(43) Pub. Date: Dec. 28, 2006

(54) Ultra wide bandwidth planar antenna

(75) Inventor: Kuo-Hua Tseng, Mei-Nung Chen (TW)

Correspondence Address: BANNER & WITCOFF, 1001 G STREET N W, SUITE 1100, WASHINGTON, DC, 20001, US

(73) Assignee: Universal Scientific Industrial Co., LTD., Tsao-Tun Chen (TW)

(21) Appl. No.: 11/157,987

(22) Filed: Jun. 22, 2005

(51) Int. Cl. H01Q 1/38

(52) U.S. Cl. 343/700 MS

(57) ABSTRACT

A planar antenna, which is operable within the ultra wide bandwidth, includes a dielectric substrate that has opposite and parallel first and second surfaces, a hexagonal radiating element that is formed on the first surface of the dielectric substrate, a feeding element that is coupled to the radiating element, and a grounding element that is formed on the second surface of the dielectric substrate.

### BACKGROUND OF THE INVENTION

1. Field of the Invention

This invention relates to a planar antenna, more particularly to an ultra wide bandwidth planar antenna.

2. Description of the Related Art

Referring to FIG. 1, a conventional ultra wide bandwidth (UWB) antenna, which operates between 3.1 and 10.6 GHz, is shown to include a radiating element 21 that has a spiral shape.

The aforesaid conventional UWB antenna is disadvantageous in that it requires a balun 22. As such, the conventional UWB antenna has a size of 27 centimeters by 42 centimeters, which is relatively large.

FIG. 2 illustrates another conventional UWB antenna that includes a grounding element 12, and a radiating element 11 that is disposed perpendicularly with respect to the grounding element 12.

The conventional UWB antenna of FIG. 2 is disadvantageous in that the grounding element 12 has a size of 10 centimeters by 10 centimeters, which is still relatively large.

### SUMMARY OF THE INVENTION

Therefore, the object of the present invention is to provide an ultra wide bandwidth planar antenna that has a relatively small size.

According to the present invention, a planar antenna, which is operable within the ultra wide bandwidth, comprises a dielectric substrate, a hexagonal radiating element, a feeding element, and a grounding element. The dielectric substrate has opposite and parallel first and second surfaces. The hexagonal radiating element is formed on the first surface of the dielectric substrate. The feeding element is coupled to the radiating element. The grounding element is formed on the second surface of the dielectric substrate.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional ultra wide bandwidth antenna;

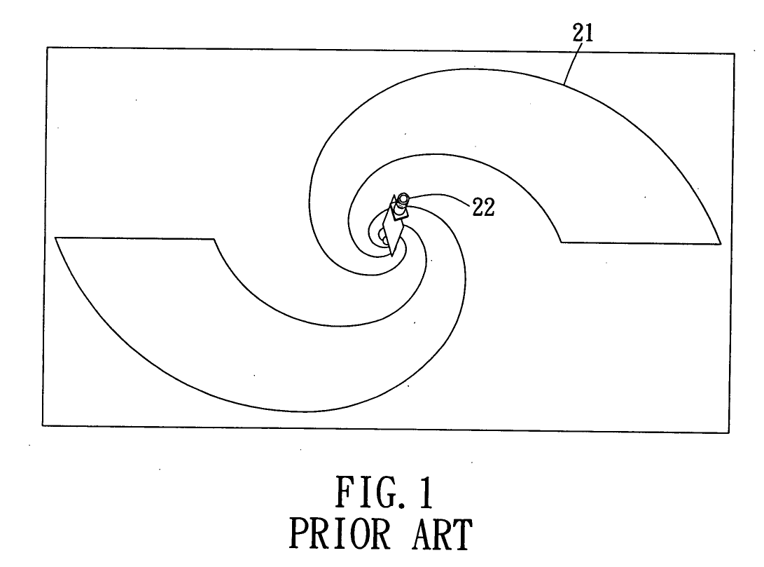

FIG. 2 is a schematic view of another conventional ultra wide bandwidth antenna;

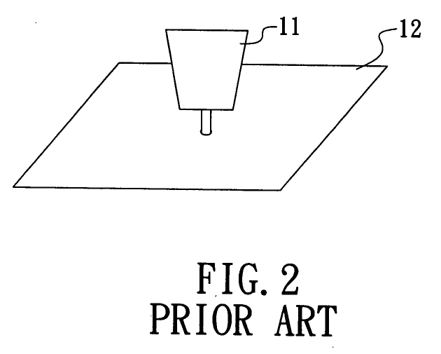

FIG. 3 is a schematic view of the first preferred embodiment of a planar antenna according to the present invention;

FIG. 4 is a plot illustrating a voltage standing wave ratio of the first preferred embodiment;

FIG. 5 is a plot illustrating a radiation pattern of the first preferred embodiment in the x-y plane;

FIG. 6 is a plot illustrating a radiation pattern of the first preferred embodiment in the x-z plane;

FIG. 7 is a schematic view of the second preferred embodiment of a planar antenna according to the present invention;

FIG. 8 is a plot illustrating a radiation pattern of the second preferred embodiment in the x-z plane; and

FIG. 9 is a plot illustrating a radiation pattern of the second preferred embodiment in the x-y plane.

### DETAILED DESCRIPTION OF THE PREFERRED EMBODIMENTS

Before the present invention is described in greater detail, it should be noted that like elements are denoted by the same reference numerals throughout the disclosure.

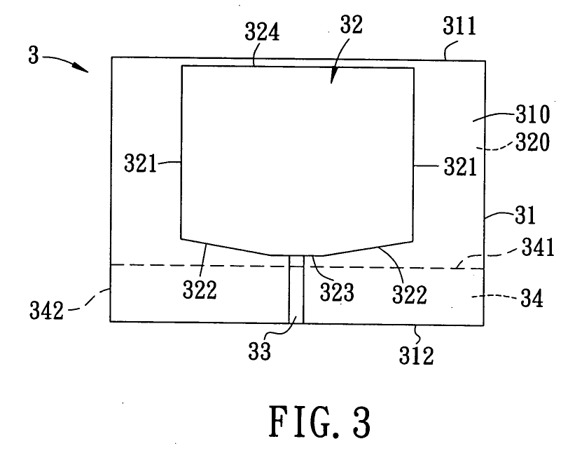

Referring to FIG. 3, the first preferred embodiment of a planar antenna 3 according to this invention is shown to include a dielectric substrate 31, a hexagonal radiating element 32, a feeding element 33, and a grounding element 34.

The planar antenna 3 of this embodiment operates within an ultra wide bandwidth, i.e., between 3.1 GHz and 10.6 GHz, and is to be mounted in a wireless electronic device (not shown).

The dielectric substrate 31 is suitable for operation in frequency within the ultra wide bandwidth. In this embodiment, the dielectric substrate 31 is generally rectangular, and has a pair of opposite edges 311, 312, and opposite and parallel first and second surfaces 310, 320. The dielectric substrate 31 has a length of 48 millimeters, a width of 34 millimeters, and a thickness of 1.6 millimeters. In this embodiment, the dielectric substrate 31 is manufactured by Rogers Corp. under a model no. RO4003C. In an alternative embodiment, the dielectric substrate is a FR-4.

The radiating element 32 is formed on the first surface 310 of the dielectric substrate 31, and has a longer side 324, a shorter side 323 opposite and parallel to and shorter than the longer side 324, a pair of first adjacent sides 321 adjacent to the longer side 324, and a pair of second adjacent sides 322 adjacent to the shorter side 323. In this embodiment, each of the first adjacent sides 321 of the radiating element 32 forms a right angle with the longer side 324 of the radiating element 32. Moreover, the radiating element 32 is disposed in such a manner that the longer side 324 of the radiating element 32 is parallel and proximate to the edge 311 of the dielectric substrate 31. Further, the longer side 324, each of the first adjacent sides 321, and each of the second adjacent sides 322 of the radiating element 32 have lengths of 30 millimeters, 25 millimeters, and 12 millimeters, respectively. Preferably, the radiating element 32 is made from copper foil. It is noted that the radiating element 32 is formed by etching in a manner well-known in the art.

The feeding element 33, preferably a microstrip line, supplies a signal from the electronic device to the radiating element 32. In this embodiment, the feeding element 33 is formed on the first surface 310 of the dielectric substrate 31. Moreover, the feeding element 33 has a first end connected electrically to the shorter side 323 of the radiating element 32, and a second end that is opposite to the first end of the feeding element 33 and that is flush with the edge 312 of the dielectric substrate 31. Further, the feeding element 33 is generally rectangular in shape, and has a dimension of 9 millimeters by 2 millimeters.

The grounding element 34 is formed on the second surface 320 of the dielectric substrate 31. In this embodiment, the grounding element 34 is generally rectangular, and has a pair of opposite longer sides 341 and a pair of opposite shorter sides 342. One of the longer sides 341 of the grounding element 34 is flush with the edge 312 of the dielectric substrate 31. Each of the longer sides 341 of the grounding element 34 has a dimension of 48 millimeters, while each of the shorter sides of the grounding element 34 has a dimension of 7.5 millimeters. It is noted that the grounding element 34 is formed by etching in a manner well known in the art.

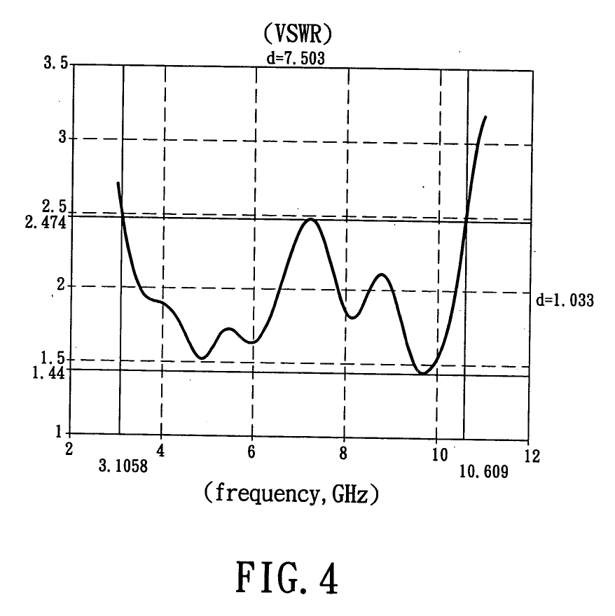

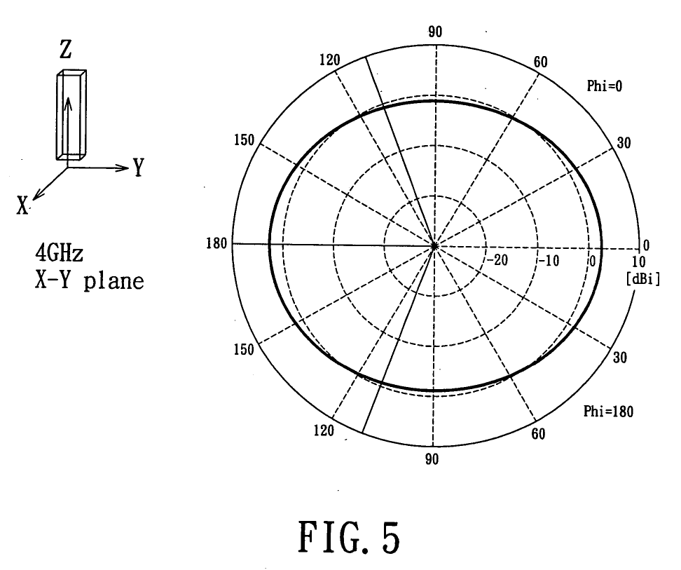

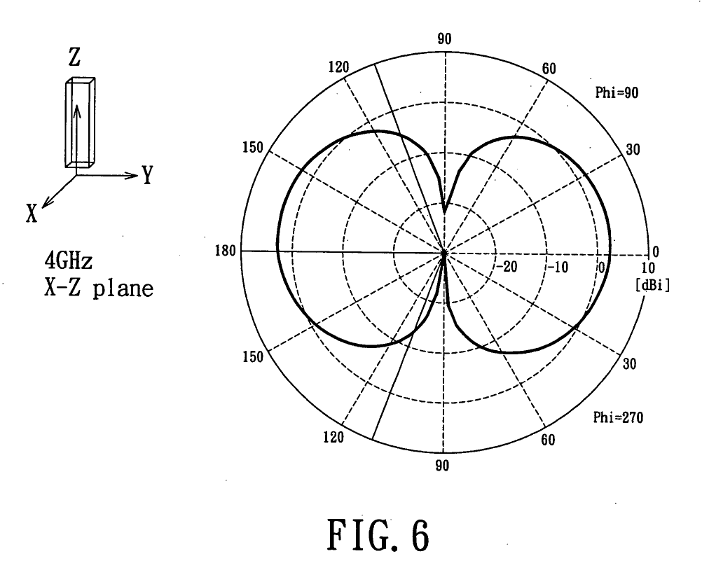

From a simulated result, with further reference to FIG. 4, when the planar antenna 3 of this invention is operated within the UWB, the planar antenna 3 has a voltage standing wave ratio (VSWR) below 2.4745. Moreover, when the planar antenna 3 of this invention is operated at 4 GHz, as shown in FIGS. 5 and 6, the planar antenna 3 has a radiation pattern that is substantially omni-directional in the X-Y plane.

It is noted that the planar antenna 3 of this invention has an input impedance of 50 Ohms, and is fed through a 50-Ohm SubMiniature version A (SMA) connector (not shown).

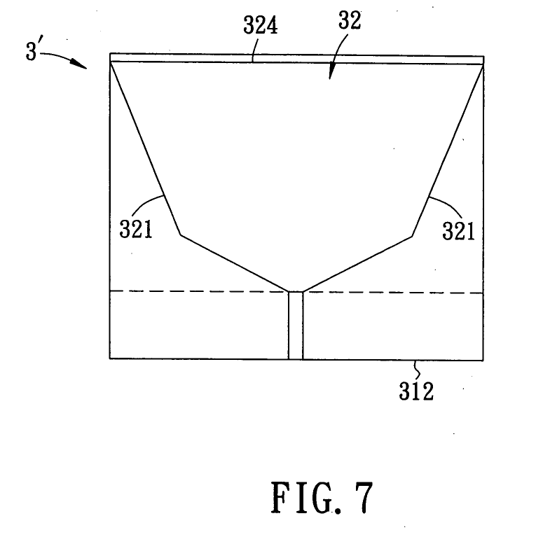

FIG. 7 illustrates the second preferred embodiment of a planar antenna 3′ according to this invention. When compared with the previous embodiment, each of the first adjacent sides 321 of the radiating element 32 forms an acute angle with the longer side 324 of the radiating element 32.

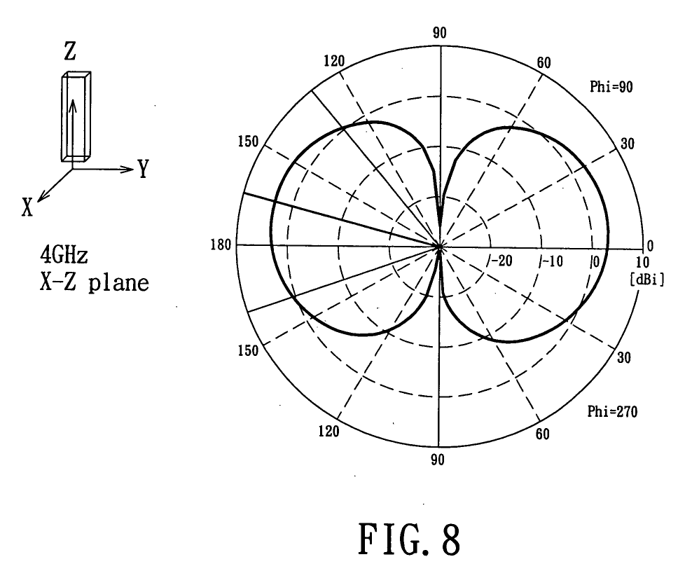

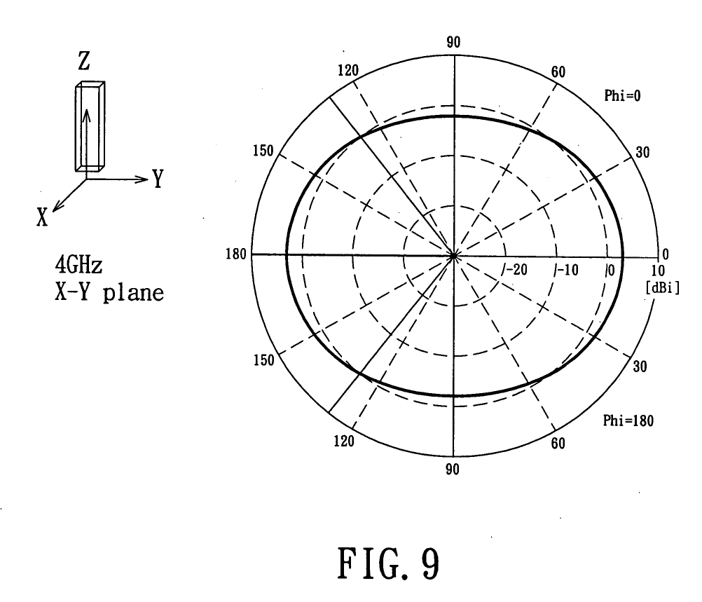

From a simulated result, when the planar antenna 3 of this invention is operated at 4 GHz, as shown in FIGS. 8 and 9, the planar antenna 3′ has a radiation pattern that is substantially omni-directional in the X-Y plane.

It has thus been shown that the planar antenna 3, 3′ of this invention includes a dielectric substrate 31 that has opposite first and second surfaces 310, 320, a radiating element 32 that is hexagonal in shape and that is formed on the first surface 310 of the dielectric substrate 31, and a grounding element 34 that is formed on the second surface 320 of the dielectric surface 31. By virtue of the hexagonal shape of the radiating element 32, and by forming the radiating and grounding elements 32, 34 on the first and second surface 310, 320 of the dielectric substrate 31, respectively, a reduced size of the planar antenna 3, 3′ of this invention can be achieved.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A planar antenna operable within the ultra wide bandwidth, comprising:
a dielectric substrate that has opposite and parallel first and second surfaces;
a hexagonal radiating element formed on said first surface of said dielectric substrate;
a feeding element coupled to said radiating element; and
a grounding element formed on said second surface of said dielectric substrate.

2. The planar antenna as claimed in claim 1, wherein said radiating element has a longer side, a shorter side that is opposite and parallel to said longer side of said radiating element and that has a length shorter than that of said longer side, a pair of opposite first adjacent sides, each of which is adjacent to said longer side, and a pair of opposite second adjacent sides, each of which is adjacent to said shorter side.

3. The planar antenna as claimed in claim 2, wherein said dielectric substrate is generally rectangular in shape, and has a first edge, said longer side of said radiating element being disposed proximate and parallel to said first edge of said dielectric substrate.

4. The planar antenna as claimed in claim 3, wherein said dielectric substrate further has a second edge opposite to said first edge of said dielectric substrate, said feeding element being formed on said first surface of said dielectric substrate, and having a first end connected to said shorter side of said radiating element, and a second end that is opposite to said first end of said feeding element and that is flush with said second edge of said dielectric substrate.

5. The planar antenna as claimed in claim 1, wherein said feeding element is a microstrip line.

6. The planar antenna as claimed in claim 1, wherein said grounding element is generally rectangular.

7. The planar antenna as claimed in claim 1, wherein said radiating element is made from copper foil.

8. The planar antenna as claimed in claim 2, wherein each of said first adjacent sides of said radiating element forms a right angle with said longer side of said radiating element.

9. The planar antenna as claimed in claim 2, wherein each of said first adjacent sides of said radiating element forms an acute angle with said longer side of said radiating element.
